(19) United States
(12) Patent Application Publication
(10) Pub. No.: US 2008/0294761 A1
(43) Pub. Date: Nov. 27, 2008

(54) ACTIVATION OF THE CONTENT OF WELCOME SCREENS WITHOUT LOSING AVAILABILITY

(76) Inventors: Stanley P. Cason, Johnson City, NY (US); James R. Crossgrove, Owego, NY (US); Nitin Jhingan, Vestal, NY (US)

Correspondence Address: HOFFMAN WARNICK LLC, 75 STATE ST, 14TH FLOOR, ALBANY, NY, 12207, US

(21) Appl. No.: 11/753,131

(22) Filed: May 24, 2007

(51) Int. Cl. G06F 15/173; G06F 15/00

(52) U.S. Cl. 709/223

(57) ABSTRACT

The present invention is directed to the activation of the content of anonymous welcome screens without losing availability. A method in accordance with an embodiment of the present invention includes: providing a wrapper application on a first set of application servers, configured for high performance and availability, with the goal of quickly providing and serving a dynamic welcome screen corresponding to the application using a second set of application servers, independent from the first set of application servers and configured for high functionality and security, wherein the content of the welcome screen is obtained by reading national language sensitive (NLS) content from corresponding updatable text storage areas; wherein the welcome screen remains available to a user regardless of an operational status of the application on the first application server.

### BACKGROUND OF THE INVENTION

1. Field of the Invention

The present invention generally relates to welcome screens. More specifically, the present invention is directed to the activation of the content of anonymous welcome screens without losing availability.

2. Related Art

Traditionally, a welcome screen offers static content associated with an application to a user, who may be anonymous. The static content of the welcome screen is generally available to the user even when the application is down. However, as soon as dynamic content is added to a welcome screen, code failure becomes an issue. Static content is much more reliable. For instance, a static HTML page for a welcome screen can reside in cache on a content server and can be quickly served to the user.

It is often desirable to provide information regarding the current status of an application on the welcome screen. However, the current status information for the application is dynamic. With a static welcome screen, if the application goes down, the content can not change to show that the application is unavailable. So, how can the application provide information about itself when it is down?

In addition, there is a desire for the screen to change based on the time of day, such as in calendar scheduling. With a static screen, an administrative person is hired to replace the content at predetermined times, or at best, an automated scheduler can stage replacements to the static screens at certain times of the day. With dynamic screens, the content can change based on the date, time or language of the user and the welcome screen can be different for each person.

Currently, developers must make a decision between availability and function. If they decide to activate a welcome screen to provide dynamic content, then they lose availability of the welcome screen if the application goes down. If they decide that availability of the welcome screen is important, then they must rely on static pages to deliver the content of the welcome screen.

### SUMMARY OF THE INVENTION

The present invention is directed to the activation of the content of anonymous welcome screens without losing availability.

A first aspect is directed to a method for activating a content of a welcome screen without losing availability, comprising: providing a wrapper application on a first set of application servers, configured for high performance and availability, with the goal of quickly providing and serving a dynamic welcome screen corresponding to the application using a second set of application servers, independent from the first application server and configured for high functionality and security, wherein the content of the welcome screen is obtained by reading national language sensitive (NLS) content from corresponding updatable text storage areas; wherein the welcome screen remains available to a user regardless of an operational status of the application on the first application server.

A second aspect is directed to a system for activating a content of a welcome screen without losing availability, comprising: a first application server for providing an application; a second application server, independent from the first application server and configured for high availability, for providing and serving a welcome screen corresponding to the application; and at least one updatable property file for providing the content of the welcome screen; wherein the welcome screen remains available to a user regardless of an operational status of the application on the first application server.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts an illustrative system for the activation of the content of an anonymous welcome screen in accordance with an embodiment of the present invention.

FIG. 2 depicts an illustrative implementation of a welcome screen in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The present invention is directed to the activation of the content of anonymous welcome screens without losing availability.

Many factors have recently come together to enable a highly available application server. For example, web application servers are becoming much more stable and the number of server code failures have begun to subside. This provides an environment that can be considered highly available. Further, server clustering and HACMP (High Availability Cluster Multi-Processing) have allowed hot failover to send applications to a different server should a hardware issue occur. In addition, a single web server can house multiple application servers on the same instance. Thus, if one application server goes down, it does not affect the other application servers residing on that web server. In this manner, a separate set of programs can run on separate ports without requiring additional hardware or incurring additional support costs.

The present invention takes advantage of the above-factors to provide a simple, “stand-alone” application server whose only purpose is to serve anonymous web pages such as welcome screens. In accordance with the present invention, as many of the potential application errors as possible are removed. No security is provided on the welcome screen, since it is a public information page, and there is no database connectivity, since a user viewing the welcome screen has not logged in yet. No third-party software is introduced, and all code is kept to a minimum with full code control and testing before deployment. All the static content is preserved in properties files stored in a special content directory so that the latest news (e.g., application availability) can be delivered on a timely basis (e.g., in real-time), and staged for deployment without affecting the running application.

In accordance with the present invention, object oriented techniques are used to encapsulate a welcome screen, servers and server farms are selected and used to deliver high availability, and the interface is simplified to minimize potential disruptions of service. In an embodiment, the welcome screen is written in JSP (JavaServer Page) (Java is a registered trademark of Sun Microsystems, Inc. in the United States and/or other countries). With this methodology, the present invention can achieve near 100% availability without sacrificing functionality, performance, usability, or reliability.

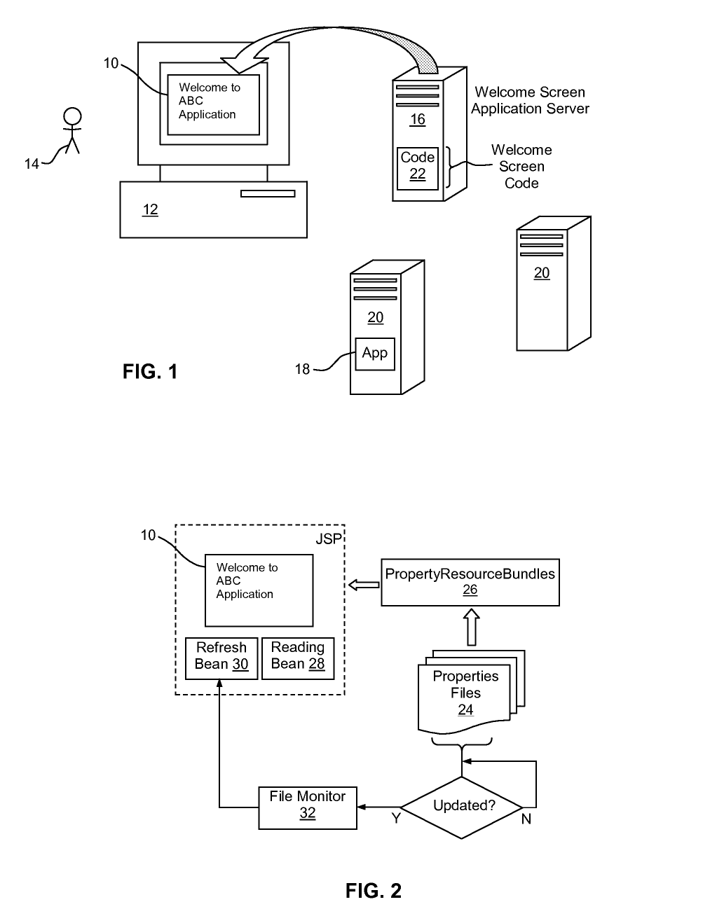

As shown in FIG. 1, a welcome screen 10 is provided and served to a computer 12 of a user 14 by its own set (one or more) of application servers 16. The user 14 may be anonymous. The welcome screen 10 will remain available to the user 14 even if its corresponding application 18, which resides on a different set (one or more) of application servers 20, is down. The welcome screen 10 is written in JSP. The various application servers 16, 20, are coupled to the computer 12 of the user 14 via a network (not shown) in a conventional manner.

The set of application servers 16 providing the welcome screen 10 is configured as simply as possible in order for it to have as high availability as possible. For example, the set of application servers 16 providing the welcome screen 10 should not have third-party software installed, such as a database backend, and as little extraneous code as possible. Only the code 22 that is necessary to support the welcome screen 10 should be on this set of application servers 16.

As detailed above, and depicted schematically in FIG. 2, the welcome screen 10 is written in JSP. The content of the welcome screen 10 itself is contained in properties files 24 that can be read into the JSP using PropertyResourceBundles 26. This class reads from the classpath, so the directory where the properties files 24 are stored needs to be in the application classpath.

Within the JSP are two bean classes, a first bean class 28 for reading the properties files 24, and a second bean class 30 for refreshing the bundles. If any of the properties files 24 are updated, a file monitor 32 fires an event that is picked up by the refresh bean 30 and clears the bundle cache, which ensures that the content of the welcome screen 10 remains current.

Because the JSP is dynamic, it can check the location of a request for the application 18. To this extent, the JSP can check the location of the request, and even though the user 14 has not logged in yet, the location of the user's browser is known. This means that the proper language for the user 14 can be dynamically loaded into the welcome screen 10 (e.g., obtained by reading national language sensitive (NLS) content from corresponding updatable text storage areas). Alternatively, the user 14 can override the browser's location by manually selecting a desired language. This will send a parameter to the JSP indicating the desired language.

The present invention can also check the status of all of the application servers 16, 20, and deliver a current status of all the geographies.

A time stamp, which is the server time, can be provided in the welcome screen 10. The time stamp indicates the exact time the information in welcome page 10 was delivered by the set of application servers 16.

There can be two sets of property files 24, one for language specific data, an another for instance specific data. As such, one JSP can be maintained, and the language specific property files can be maintained separately.

Some/all aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal traveling over a network (e.g., during a wired/wireless electronic distribution of the computer program code).

It should be appreciated that the teachings of the present invention could be offered as a business method on a subscription or fee basis. For example, a service provider can create, maintain, enable, and deploy an audience response detection interactive presentation tool, as described above.

The foregoing description of the embodiments of this invention has been presented for purposes of illustration and description. It is not intended to be exhaustive or to limit the invention to the precise form disclosed, and many modifications and variations are possible.

What is claimed is:

1. A method for activating a content of a welcome screen without losing availability, comprising:
providing an application on a first application server; and
providing and serving a welcome screen corresponding to the application using a second application server, independent from the first application server and configured for high availability, wherein the content of the welcome screen is obtained by reading at least one updatable property file;
wherein the welcome screen remains available to a user regardless of an operational status of the application on the first application server.

2. The method of claim 1, wherein the welcome screen comprises an anonymous welcome screen.

3. The method of claim 1, wherein providing the welcome screen further comprises:
writing the welcome screen in JavaServer Page (JSP); and
reading the at least one property file into the JSP.

4. The method of claim 3, wherein the JSP comprises a reading bean for reading the at least one property file and a refresh bean for ensuring that the content of the welcome remains current.

5. The method of claim 4, further comprising, in response to an updating of the at least one property file:
firing an event using a file monitor; and
picking up the event by the refresh bean.

6. The method of claim 1, further comprising:
determining a location of a request for the application; and
dynamically loading the content into the welcome screen using a language associated with the location of the request.

7. A system for activating a content of a welcome screen without losing availability, comprising:
a first application server for providing an application;
a second application server, independent from the first application server and configured for high availability, for providing and serving a welcome screen corresponding to the application; and
at least one updatable property file for providing the content of the welcome screen;
wherein the welcome screen remains available to a user regardless of an operational status of the application on the first application server.
